(19) United States
(12) Patent Application Publication
(10) Pub. No.: US 2026/0332600 A1
(43) Pub. Date: Oct. 22, 2026

(54) DECENTRALIZED IDENTITY AUTHENTICATION AND AUTHORIZATION

(71) Applicant: Lenovo (Singapore) Pte. Limited, Singapore (SG)

(72) Inventor: Sheeba Backia Mary Baskaran, Friedrichsdorf (DE)

(73) Assignee: Lenovo (Singapore) Pte. Limited, Singapore (SG)

(21) Appl. No.: 19/111,214

(22) PCT Filed: Sep. 18, 2023
(86) PCT No.: PCT/IB2023/059243

§ 371 Date: Mar. 12, 2025

Related U.S. Application Data
(60) Provisional application No. 63/408,627, filed on Sep. 21, 2022.
(60) Provisional application No. 63/408,639, filed on Sep. 21, 2022.
(60) Provisional application No. 63/408,645, filed on Sep. 21, 2022.

(51) Int. Cl. H04L 9/40

(52) U.S. Cl. CPC H04L 63/105

(57) ABSTRACT

Various aspects of the present disclosure relate to platform services to support identity, including decentralized identifier (DID) and self-sovereign identity (SSI) based, and trust management solutions that use a ledger platform such as a permissioned distributed ledger (PDL). A DID verification procedure to enable authentication and authorization of DID holders (e.g., subject or end user) for end user requested services is discussed. This DID verification procedure includes a DID verification service receiving a DID verification request and a type of service requested from a DID verifier, communicating with a DID operation participants registry service and a DID document registry service to determine whether the DID holder is authorized to access the type of service, and returning an indication of authorization success or failure to the DID holder.

### RELATED APPLICATIONS

This application claims priority to U.S. Provisional Application Ser. No. 63/408,645 filed Sep. 21, 2022 entitled “Decentralized Identity Authentication and Authorization,” the disclosure of which is incorporated by reference herein in its entirety. This application also claims priority to U.S. Provisional Application Ser. No. 63/408,639 filed Sep. 21, 2022 entitled “Registration Handling of Ledger-Based Identity,” the disclosure of which is incorporated by reference herein in its entirety. This application also claims priority to U.S. Provisional Application Ser. No. 63/408,627 filed Sep. 21, 2022 entitled “Digital Identity Management,” the disclosure of which is incorporated by reference herein in its entirety.

### TECHNICAL FIELD

The present disclosure relates to wireless communications, and more specifically to decentralized identity authentication and authorization.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Various situations arise when using wireless communications systems where an end user, device, or service needs to be authenticated, such as to determine access to various resources, such as particular services, data, and so forth. Wireless communications systems support various different types of authentication techniques allowing users, devices, or services to gain access to these various resources.

### SUMMARY

The present disclosure relates to methods, apparatuses, and systems that support decentralized identity authentication and authorization. The techniques discussed herein are directed to platform services to support identity, including decentralized identifier (DID) and self-sovereign identity (SSI) based, and trust management solutions that use a ledger platform such as a permissioned distributed ledger (PDL). The techniques discussed herein include a DID verification procedure to enable authentication and authorization of DID holders (e.g., subject or end user) for end user requested services. This DID verification procedure includes a DID verification service receiving a DID verification request and a type of service requested from a DID verifier, communicating with a DID operation participants registry service and a DID document registry service to determine whether the DID holder is authorized to access the type of service, and returning an indication of authorization success or failure to the DID verifier (to be provided to the DID holder). By providing such services and DID verification procedure, DID holders can be authenticated and authorized for end user requested services, which has previously been unavailable by current PDL platforms.

Some implementations of the method and apparatuses described herein may further include to: receive, from a DID verifier, a first signaling indicating a DID verification request that includes one or more of a source identifier of the DID verifier, a DID, and a DID service type; transmit, to the DID verifier, a second signaling indicating an authorization data request; receive, from the DID verifier, a third signaling indicating an authorization data response including a registration identifier of the DID verifier and authorization information; transmit, to a first registry service, a fourth signaling indicating an authorization verification request that includes the registration identifier of the DID verifier and the authorization information; receive, from the first registry service, a fifth signaling indicating an authorization verification response of success or failure; transmit, to the DID verifier, a sixth signaling indicating a DID verification response of DID verification success or DID verification failure.

In some implementations of the method and apparatuses described herein, the method and apparatuses are further to, in response to the fifth signaling indicating the authorization verification response of success: transmit, to a second registry service, a seventh signaling indicating a DID verification data request that includes the DID; receive, from the second registry service, an eighth signaling indicating a DID verification data response that includes the DID, one or more DID documents, and metadata; and transmit, to the DID verifier, the sixth signaling indicating the DID verification response of DID verification success, a DID document and metadata. Additionally or alternatively, the method and apparatuses are further to, in response to the fifth signaling indicating the authorization verification response of failure: transmit, to the DID verifier, the sixth signaling indicating the DID verification response of DID verification failure. Additionally or alternatively, the sixth signaling further indicates a reason for the DID verification response of DID verification failure. Additionally or alternatively, the DID verifier comprises an application server or service provider application function. Additionally or alternatively, the method and apparatuses are further to transmit, to the DID verifier, a seventh signaling to establish a secure connection between the DID verifier and the apparatus. Additionally or alternatively, the authorization data request includes an identifier of the DID verifier. Additionally or alternatively, the authorization verification request includes one or more of the registration identifier of the DID verifier, an identifier of the DID verifier, an indication of an access role as DID verifier, and the authorization information. Additionally or alternatively, the authorization information comprises an authorization code or token. Additionally or alternatively, the authorization verification response includes one or more of the registration identifier of the DID verifier, an identifier of the DID verifier, and the authorization verification response of success or failure.

Some implementations of the method and apparatuses described herein may further include to: receive, from a DID verification service, a first signaling indicating an authorization verification request that includes a registration identifier of a DID verifier and authorization information; transmit, to the DID verification service, a second signaling indicating an authorization verification response of success or failure.

In some implementations of the method and apparatuses described herein, the method and apparatuses are further to: check a ledger or storage to determine whether the registration identifier and the authorization information match a record of a participant involved in an identity and trust management framework, and whether an access role of the participant is correct; and verify, based on the checking, the authorization information related to the registration identifier. Additionally or alternatively, the authorization verification request includes one or more of the registration identifier of the DID verifier, an identifier of the DID verifier, an indication of an access role as DID verifier, and the authorization information. Additionally or alternatively, the authorization information comprises an authorization code or token. Additionally or alternatively, the authorization verification response includes one or more of the registration identifier of the DID verifier, an identifier of the DID verifier, and the authorization verification response of success or failure.

Some implementations of the method and apparatuses described herein may further include to: receive, from a DID verification service, a first signaling indicating a DID verification data request that includes the DID; transmit, to the DID verification service, a second signaling indicating a DID verification data response that includes the DID, one or more DID documents, and metadata.

In some implementations of the method and apparatuses described herein, the method and apparatuses are further to: transmit, to a verifiable credential (VC) registry service, a third signaling indicating a VC request that includes the DID; and receive, from the VC registry service, a fourth signaling indicating a VC response that includes the DID and VCs associated with the DID. Additionally or alternatively, the method and apparatuses are further to: fetch the one or more DID documents related to the DID; and generate the metadata from VCs to enable a DID verifier to authenticate and authorize the DID and a DID holder.

### BRIEF DESCRIPTION OF THE DRAWINGS

FIG. 1 illustrates an example of a wireless communications system that supports decentralized identity authentication and authorization in accordance with aspects of the present disclosure.

FIG. 2 illustrates an example of verifiable claim(s) generation and use related to identity authentication and verification, as related to decentralized identity authentication and authorization in accordance with aspects of the present disclosure.

FIG. 3 illustrates an example of DID registry on distributed ledger and blockchain, as related to registration handling of ledger-based identity in accordance with aspects of the present disclosure.

FIG. 4 illustrates a system presenting an example architecture for identity management and identity verification in the perspective of SSI.

FIG. 5 illustrates an example PDL platform service-based identity and trust management framework that supports decentralized identity authentication and authorization in accordance with aspects of the present disclosure.

FIGS. 6A and 6B illustrate an example flow diagram that supports decentralized identity authentication and authorization in accordance with aspects of the present disclosure.

FIGS. 7 through 9 illustrate examples of block diagrams of devices that support decentralized identity authentication and authorization in accordance with aspects of the present disclosure.

FIGS. 10 through 16 illustrate flowcharts of methods that support decentralized identity authentication and authorization in accordance with aspects of the present disclosure.

### DETAILED DESCRIPTION

The digital identity management related to DID and SSIs involves various processes such as storage, management and handling, verification of identities and relevant documents (e.g., Verifiable Credentials (VC), cryptography related information, etc.), and selective data disclosure in a distributed platform (e.g., PDLs) to enable digital identity-based authentication and authorization. Further the process involves multiple actors such as an identity holder, a DID controller, a VC Issuer, a relying party (e.g., a verifier), and so forth. However, the current PDL platform does not offer services to support a digital identity specific identity and trust management process that involves storage, management and handling, verification and management of multiple actors (e.g., access control and authorization), selective data disclosure to the relying party, and so forth.

The techniques discussed herein are directed to platform services to support identity, including DID and SSI based, and trust management solutions that use a ledger platform such as a PDL. The techniques discussed herein include a DID verification procedure to enable authentication and authorization of DID holders (e.g., subject or end user) for end user requested services. This DID verification procedure includes a DID verification service receiving a DID verification request and a type of service requested from a DID verifier, the DID verification request including one or more of a source identifier of the DID verifier, a DID, and a DID service type. The DID verification service transmits an authorization data request to the DID verifier, and receives from the DID verifier an authorization data response including a registration identifier of the DID verifier and authorization information. The DID verification service transmits an authorization verification request that includes the registration identifier of the DID verifier and the authorization information to a DID operation participants registry service and also receives, from the DID operation participants registry service, an authorization verification response of success or failure. If the authorization verification response is success, the DID verification service transmits a DID verification data request that includes the DID to a DID document registry service, and receives from the DID document registry service a DID verification data response that includes the DID, one or more DID documents, and metadata. The DID verification service transmits to the DID verifier, in the event of an authorization verification response of success, the DID verification response of DID verification success, a DID document and metadata. In the event of an authorization verification response of failure, the DID verification service transmits an indication of failure to the DID verifier.

Using the techniques discussed herein, DID holders can be authenticated and authorized for end user requested services, which has previously been unavailable by current PDL platforms.

Current PDL platform services related to registration, application registration, identity, and identity management are not sufficient to support the decentralized identity management and related verification process due to various limitations. For example, current registration service and application registration service do not support role-based access control and authorization setting for registration, which can be very important in order to handle different parties and their operations for a decentralized identity and trust management framework. By way of another example, current identity and identity management services do not allow the identity holder (e.g., an end device or application) to set an identifier for itself and do not allow (e.g., as an identity controller) to set an identifier for another device or object associated with it. By way of another example, current PDL services do not support selective data sharing specific to the managed identifiers. The techniques discussed herein support the decentralized identity management and related verification process, allowing DID holders to be authenticated and authorized for end user requested services.

Aspects of the present disclosure are described in the context of a wireless communications system. Aspects of the present disclosure are further illustrated and described with reference to device diagrams and flowcharts.

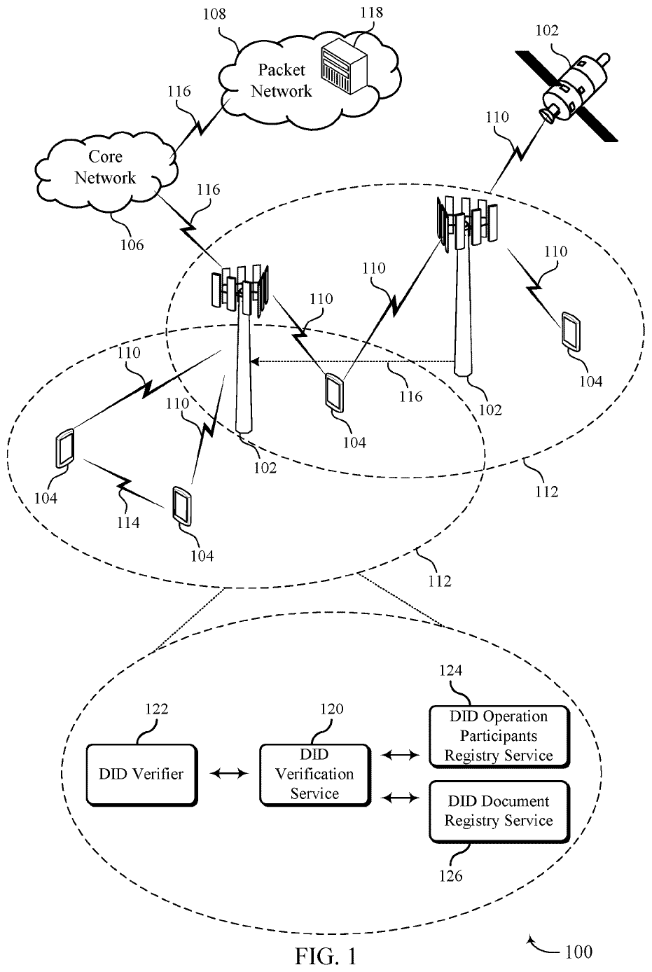

FIG. 1 illustrates an example of a wireless communications system 100 that supports decentralized identity authentication and authorization in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing.

FR 2 may be associated with one or multiple numerologies (e.g., at least 2 numerologies). For example, FR 2 may be associated with a third numerology (e.g., μ=2), which includes 60 kHz subcarrier spacing; and a fourth numerology (e.g., μ=3), which includes 120 kHz subcarrier spacing.

The wireless communications system 100 includes a DID verification service 120, a DID verifier 122, a DID operation participants registry service 124, and a DID document registry service 126. The DID verifier 122 is an entity that receives a DID from an end device, client, or application for a service request. The DID verification service 120 receives from the DID verifier 122 a DID verification request indicating a type of service requested. The DID verification service 120 communicates with the DID operation participants registry service 124 and the DID document registry service 126 to determine whether the DID holder is authorized to access the type of service, and returns an indication of authorization success or failure to the DID verifier 120. The DID operation participants registry service 124 records and keeps track of the registered and de-registered identity and trust management framework participants based on instructions from a role based registration management service. The DID document registry service 126 stores and manages the DID documents associated with the DID to facilitate DID verification.

In one or more implementations, the DID verification service 120, the DID verifier 122, the DID operation participants registry service (can be alternatively termed as Ledger-Identity and trust management participant registry service) 124, and the DID document registry service 126 are included as part of the core network 106. Additionally or alternatively, one or more of the DID verification service 120, the DID verifier 122, the DID operation participants registry service 124, and the DID document registry service 126 may be implemented external to the core network 106.

Various communications between ones of the DID verification service 120, a DID verifier 122, a DID operation participants registry service 124, and a DID document registry service 126 allow for decentralized identity authentication and authorization as discussed in more detail below. These communications can be made using any of a variety of signaling, such as data or control signaling, using any of various techniques such as RRC, SDAP, PDCP, MAC, and so forth.

Decentralized identity and/or SSI based identity management solutions are discussed in the context of trust framework created by the eIDAS Regulation. According to the current DID specification of W3C, DIDs are a new type of identifier for verifiable, “self-sovereign” digital identity. DIDs are fully under the control of the DID subject, independent from any centralized registry, identity provider, or certificate authority. DIDs are URLs that relate a DID subject to means for trustable interactions with that subject. DIDs resolve to DID documents, which are simple documents that describe how to use that specific DID. Each DID document may contain at least proof purposes, verification methods, and service endpoints. The proof purposes are combined with verification methods to provide mechanisms for proving things. For example, a DID document can specify that a particular verification method, such as a cryptographic public key or pseudonymous biometric protocol, can be used to verify a proof that was created for the purpose of authentication. Service endpoints enable trusted interactions with the DID controller.

As DIDs are just an identifier, they do not provide information about the subject itself. In practice, DIDs are used in combination with verifiable claims to support digital interactions in which information about the subject is shared with third parties, by proving to those third parties that the DID subject has ownership of certain attestations or attributes. This proof is based on the cryptographic link between the verifiable claims, the DID subject the verifiable claims is about, and the issuer of the verifiable claims, which can be the own DID subject (self-asserted claims), or a trusted entity. Trust on the issuer is established either by trusting the issuer's DID (e.g. out-of-band, bilateral relationship, trusted lists) or by any other means. The third party can then use the presented cryptographically protected proof to verify the ownership and trustworthiness of the claims about the subject. As the presentation of the claims is managed totally by the users, they can decide on which specific pieces of information about themselves they want to share with third parties, by which selective disclosure of attributes privacy and personal data protection is reinforced.

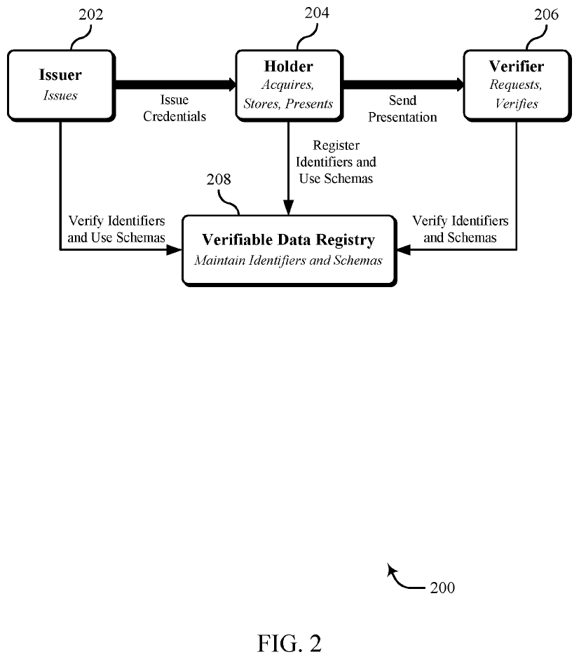

FIG. 2 illustrates an example 200 of verifiable claim(s) generation and use related to identity authentication and verification, as related to decentralized identity authentication and authorization in accordance with aspects of the present disclosure. The flow of information of the verifiable claims generation and use, as shown in the example 200, is derived from the W3C working draft of the verifiable credentials data model (1.0). In this data model, credentials are considered as a set of one or more claims made by an issuer 202 and may also include credential metadata and one or more proofs. In this example 200, the issuer 202 issues credentials to a holder 204 that acquires, stores, and presents the credentials. The holder 204 sends a presentation to a verifier 206 that requests and verifies. A verifiable data registry 208 receives input from the issuer 202, from the holder 204, and from the verifier 206, and the verifiable data registry 208 maintains identifiers and schemas.

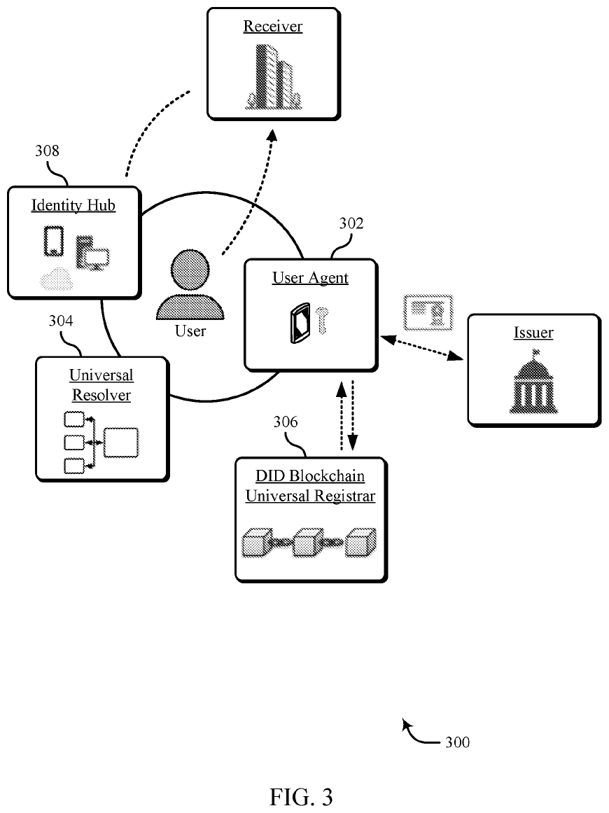

FIG. 3 illustrates an example 300 of DID registry on distributed ledger and blockchain, as related to registration handling of ledger-based identity in accordance with aspects of the present disclosure. To implement DID and VC, organizations working on SSI rely on the use of distributed ledgers and/or blockchains to support the registry of identifiers. In particular, the Decentralized Identity Foundation (DIF) proposes the architecture shown in the example 300, which includes several components. For example, a user agent 302 is a program, such as a browser, mobile application, or other web-based client, that mediates the communication between holders (204), issuers (202), and verifiers (206). A universal resolver 304 is a server featuring a pluggable system of DID method drivers that enables resolution and discovery of DIDs across any decentralized system. A universal registrar 306 is a server that enables the registration of DIDs across any decentralized system that produces a compatible driver. Additionally, an identity hub 308 is a secure personal datastore that coordinates storage of signed and/or encrypted data, and relays messages to identity-linked devices.

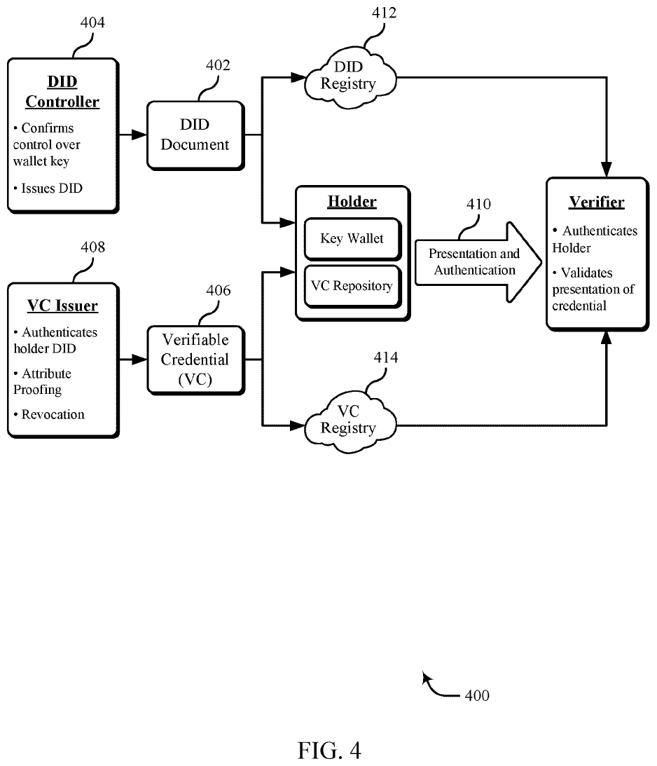

FIG. 4 illustrates a system 400 presenting an example architecture for identity management and identity verification in the perspective of SSI. The system 400, for example, includes the following architectural elements:
DID: A type of identifier that enables verifiable, decentralized digital identity. A DID can refer to any subject (e.g., a person, organization, thing, data model, abstract entity, etc.) as determined by a controller of the DID. A DID may be considered as a form of pseudonym as it may not directly linked to a formal identifier of a natural or legal person.
DID Document 402: DID documents contain information associated with a DID. They typically express verification methods, such as cryptographic public keys, and services relevant to interactions with the holder. A DID document may be signed by a DID Controller.
DID Controller 404: The controller of a DID is the entity (e.g., person, organization, autonomous software, etc.) that has the capability-as defined by a DID method-to make changes to a DID document. The following secure processes for the DID controller can be utilized:
   Proof of possession or control of the holder of its private key
   Issuance of a unique DID to the holder
VC 406: A set of one or more claims made by an issuer. A verifiable credential is a tamper-evident credential that has authorship that can be cryptographically verified.
VC Issuer 408: A role an entity can perform by asserting claims about one or more subjects, creating a verifiable credential from these claims, and transmitting the verifiable credential to a holder. The following secure processes are for the DID controller can be utilized:
   Authentication of the Holder As Identified by its Did
   Proofing that the claimed attributes belong to the holder
   Revocation of a Holder's Attributes
Presentation 410: Data derived from one or more verifiable credentials, issued by one or more issuers, that is shared with a specific verifier. A verifiable presentation is a tamper evident presentation encoded in such a way that authorship of the data can be trusted after a process of cryptographic verification.
Repository: A program, such as a storage vault or personal verifiable credential wallet, that stores and protects access to holders' verifiable credentials. The use of the repository can be restricted to the holder or other authorized parties.
Key Wallet: Application used to generate, manage, store or use private and public keys. A Key Wallet may be protected by specially protected “secure element” within the Wallet. The use of the keys can be restricted to the holder.
Wallet: A Wallet can be used to cover the repository of verifiable data (DID documents, verifiable credentials) and a Key Wallet. A Wallet may be considered as a form of Secure Area (SA-Application). For instance, this may be supported through use of an agent service that is remotely accessed from the user's device and controlled through use of multiple authentication factors.
DID Registry 412: In order to be resolvable to DID documents, DIDs can be recorded on an underlying system or network of some kind. Regardless of the specific technology used, any such system may be used that supports recording DIDs and returning data necessary to produce DID documents. This can be referred to as the DID document registry. The DID registry can be based on a distributed ledger such as blockchain.
VC Registry 414: A role a system may perform by mediating the creation and verification of identifiers, keys, and other relevant data, such as verifiable credential schemas, revocation registries, issuer public keys, and so on, which might be specified to use verifiable credentials. Some configurations might use correlate identifiers for subjects. Some registries, such as ones for UUIDs and public keys, might act as namespaces for identifiers.
Holder Authentication: A protocol exchange to obtain authorized access to a resource.

In an example implementation, the European Telecommunications Standards Institute (ETSI) PDL reference architecture describes services such as registration services, identity services and identity management services (among other services) as described below.

Registration: List a managed object with authorities or registries according to Clause 5.4.2.5 ETSI-ISG-PDL Registration Platform Service. Registration services can provide means to list an ETSI-ISG-PDL Managed Object with local or international authorities or registries. Such registries allow reference to such Managed Objects for legal, commercial and Operational purposes. Registration requirements may vary with geography, though not all registries are linked to the geography in which they are used. Certain Managed Objects (e.g. a PDL serving a geographically diverse application) operate in multiple geographies and may require multiple registrations. An ETSI-ISG-PDL Managed Object may be registered in one or more registries. A registered ETSI-ISG-PDL Managed Object is to be registered in accordance with the regulations and rules applicable in the geographies in which it operates.

Application Registration: Registers and lists all applications operated on a platform. According to Clause 5.4.3.21.6 Application Registration, Application registration is a functionality that registers and lists all applications operated on a platform. An ETSI-ISG-PDL platform is to maintain a list of all applications registered and operated on it.

Identity: Unambiguously identifies an instance of an entity from other instances of this and other objects. According to clause 5.4.2.3 ETSI-ISG-PDL Identity Platform Service the Identity of an entity is a set of context-dependent digital identifiers that unambiguously identify an instance of that entity from all other instances of this and other objects. An identity may use multiple attributes to uniquely identify it (e.g. two products with the same name have other different attributes, such as different serial numbers).

An ETSI-ISG-PDL Identity is to be constructed using one or more context-dependent digital identifiers that enable an object instance to be unambiguously identified. A digital identifier is a secure object that is unique within a particular namespace. It is recommended that every digital identifier is assigned a namespace. An ETSI-ISG-PDL digital identifier can be defined within a namespace to guarantee its uniqueness. An entity may be used in different situations. Therefore, the same entity may be identified using a different set of digital identifiers for each situation. This enables the semantics of the use of an entity in each situation to be taken into account.

An ETSI-ISG-PDL Managed Object may have multiple context-dependent digital identifiers for establishing the Identity of that Managed Object in different situations in which it is used. An ETSI-ISG-PDL Identity Service provides a single identity token per instance of an entity for all services so that this instance is identified unambiguously and in the same manner by all services. An ETSI-ISG-PDL Identity Service is to provide a single digital identity token per instance of an entity.

Identity Management: Access control based on the identity of an entity. According to clause 5.4.3.4.6 ETSI-ISG-PDL Identity Management Platform Service Identity Management defines access control based on the identity of an entity that initiates a particular set of operations on a target according to a set of criteria. The ETSI-ISG-PDL Identity Management Platform Service depends on the ETSI-ISG-PDL Namespace Platform Service and the ETSI-ISG-PDL Identity Platform Service.

An Identity-Management Platform Service is to be implemented in all ETSI-ISG-PDL compliant platforms. The Identity Management Platform Service and the Identity Platform Service can be two distinct and different services. The Identity Platform service defines how identities are assigned, while the Identity Management Platform Service defines how access is managed based on an assigned identity.

Thus, implementations have been described pertaining to registration, application registration, identity, and identity management. Such implementations, however, exhibit drawbacks in terms of supporting the decentralized identity management and related verification processes as shown by the following limitations.
(i) Registration service and application registration service do not support role-based access control and authorization setting as part of registration which can be very important to handle different parties and their operations for a decentralized identity and trust management framework.
(ii) The identity and identity management service does not enable an identity holder (e.g., an end-device and/or application) to set an identifier for itself or allow the identity holder (e.g., as an identity controller) to set an identifier for another device and/or object associated to it.
(iii) The existing PDL services do not support selective data sharing specific to managed identifier(s).

The techniques discussed herein describe a set of PDL platform services to support identity (e.g., DID and SSI based) and trust management solutions that relies upon a PDL or any ledger platform. These services include a role based registration management service, a DID operation participants registry service (also referred to as ledger-Identity and trust management participant registry service), a DID registry/DID resolver service, a DID document registry service (e.g., create/store, update, delete/revoke), a VC data registry service (e.g., create/store, update, delete/revoke), and a DID verification service.

A ledger-based Identity and Trust management solution involves various aspects, such as the following: 1) (role-based) registration of participants who interact and get involved in the identity and trust management framework to enable a DID based authentication and authorization of DID holders (e.g., subject/end-user); 2) de-registration/revocation of registered participants who interact and get involved in the identity and trust management framework; 3) storage and management (create/store, update and delete) of DID associated DID Documents and verifiable credentials in the ledger; 4) DID verification procedure to enable authentication and authorization of DID holders (e.g., subject/end-user) to provide end-user requested services.

In one or more implementations, a verifier (e.g., a DID verifier/ID verifier, such as a service provider) can utilize the PDL service to verify a DID related to an end-device/user (e.g., DID holder) to authenticate the end device (which requests a service that is offered by the service provider) utilizing the ledger-based Identity and trust management framework.

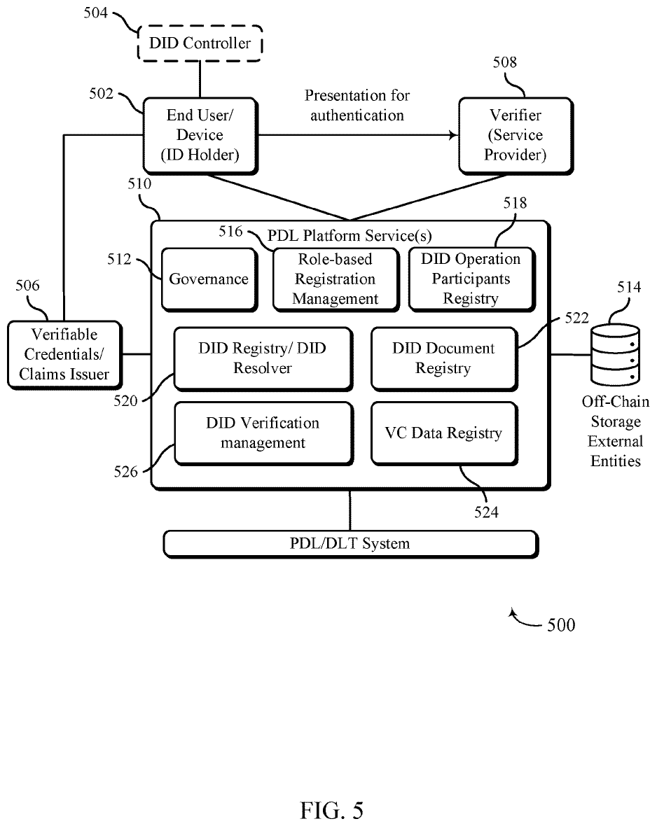

FIG. 5 illustrates an example PDL platform service-based identity and trust management framework 500 that supports decentralized identity authentication and authorization in accordance with aspects of the present disclosure. In the framework 500, the identity holder 502 (which can be referred as the subject, e.g., a person, organization, thing, data model, abstract entity, function, end-user, device etc.) can generate a digital identifier (such as a DID or an SSI either by itself or the digital identifier can be generated and provisioned to the identity holder 502 by the service provider or a DID controller 504 (e.g., another party that creates the digital identifier on behalf of the identity holder 502 to identify and authenticate the identity holder 502). For example, an organization can be an identity controller for its employees who are the identity holders, or a person can be the identity controller for the Internet of things (IOT) object associated to the person, where the IoT object can be the identity holder, etc.

A verifiable credentials/claims issuer (VC Issuer) 506 can perform asserting claims about one or more subjects, creating verifiable credentials (VCs) from these claims (e.g., passport, driving license, and birth certificate), and transmitting the verifiable credential to a holder. The VC includes a set of one or more claims made by an issuer. A VC is a tamper-evident credential that has authorship that can be cryptographically verified. The identity holder 502 presents the data (e.g., for authentication and authorization) derived from one or more verifiable credentials, issued by one or more issuers, that is shared with a specific verifier. A verifiable presentation is a tamper evident presentation encoded in such a way that authorship of the data can be trusted after a process of cryptographic verification to enable any verifier 508 (such as a service provider or 3rd party service provider) to verify the DID and authenticate the identity holder/subject.

In one or more implementations, in addition to existing PDL services, the PDL services 510 include services related to role-based registration, storage and management of DIDs, DID documents, VCs, verification of DIDs and selected exposure of data/claims (e.g., as indicated for the service). Further the DID based identity framework may also include services related to governance 512 (i.e., Governance Platform Services can be a collection of rules and tools that control the behavior and function of a PDL Platform to enable identity and trust management) and off-chain storage 514 (e.g., storing of information in a digital, machine-readable medium that is not stored on the main chain) to enable scaling of blockchain-based applications that are data-intensive and/or data sensitive such as VCs. The off-chain storage 514 is often used to store non-transactional data that is too large to be stored in the blockchain efficiently or requires the ability to be changed or deleted. Off-Chain data is typically only accessible by a subset of the nodes participating in a chain.

The PDL services 510 include a role based registration management service 516 (i.e., operation may involve registration, revoke/de-registration). The role-based registration management service 516 considers the different roles, actors, or participants to be involved in the identity and trust management framework, and it provides registration service (along with authorization) specific to the corresponding roles of the actor in the PDL platform. These different roles, actors, or participants include one or more of an identity holder, an identity controller, a VC Issuer, an ID verifier, and so forth (e.g., any participant or stakeholder to be involved in the identity and trust management framework.

The PDL services 510 include a DID operation participants registry service 518, which records and keeps track of the registered and de-registered identity and trust management framework participants in the PDL platform based on instructions from the role-based registration management service 516.

The PDL services 510 include a DID Registry/DID Resolver service 520, which stores and keeps track of the DID(s) and its associated DID document location information (e.g., address) to enable DID document fetching and verification by the authorized services and entities.

The PDL services 510 include a DID document registry service 522 (e.g., operation may involve create/store, update, delete/revoke DID documents). The DID document registry service 522 can store and manage the DID documents associated with the DID to facilitate DID verification. Each DID document may contain at least three things: proof purposes, service specific information for which the DID document can be used, verification methods, and service endpoints. Proof purposes are combined with verification methods to provide mechanisms for proving things. For example, a DID document can specify that a particular verification method, such as a cryptographic public key or pseudonymous biometric protocol, can be used to verify a proof that was created for the purpose of authentication. Service endpoints enable trusted interactions with the DID controller as well as an authorized verifier.

The PDL services 510 include a VC Data Registry service 524 (e.g., operation may involve create/store, update, delete/revoke VCs). The VC registry service 524 can store and manage the VCs associated with the DID to facilitate VC based DID verification and validation related to a service request.

The PDL services 510 include a DID verification service 526, also referred to as DID verification management: The DID verification service 526 may be a composite service that uses the DID registry service/DID resolver service 520, the DID document registry service 522, and the DID operation(al) participants registry service 518 to fetch necessary data related to verification of DID (e.g., authentication of the subject identified by the DID), and exposure of selective data to the verifier to enable authorization verification of subject to respective service(s).

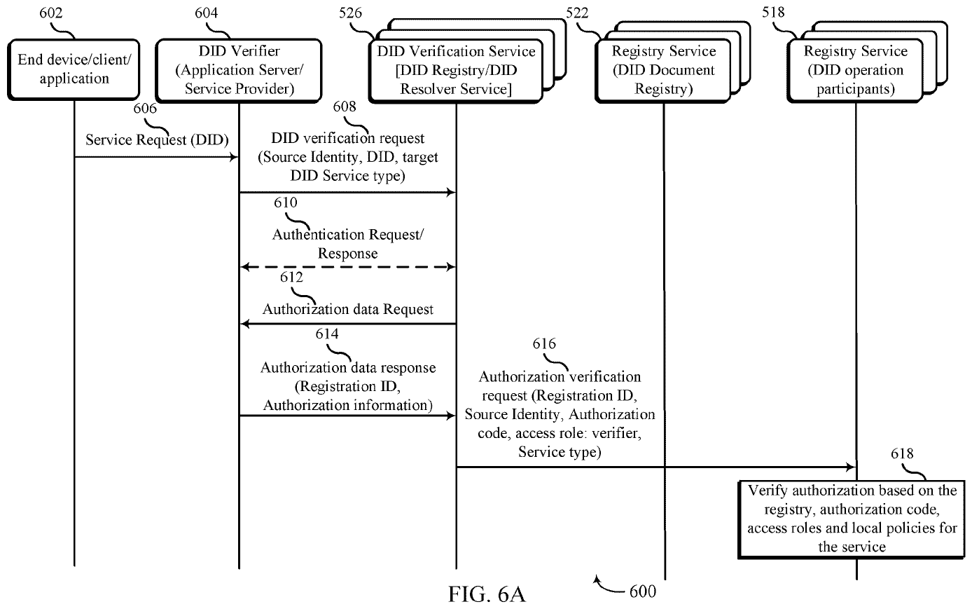

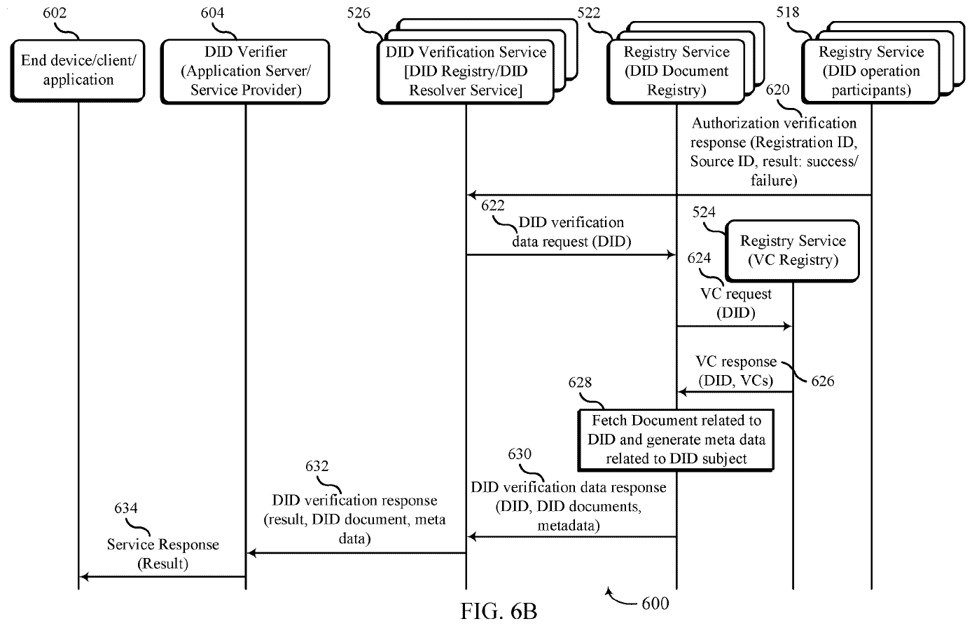

FIGS. 6A and 6B illustrate an example flow diagram 600 that supports decentralized identity authentication and authorization in accordance with aspects of the present disclosure. The flow diagram 600 illustrates DID verification and DID holder authentication using a DID verification service offered by the ledger-based identity and trust management framework.

A DID is a type of identifier that enables verifiable, decentralized digital identity. A DID refers to any subject (e.g., a person, organization, thing, data model, abstract entity, etc.) as determined by the controller of the DID. In one or more implementations, only natural and legal person are considered as subjects. A DID may be considered as a form of pseudonym as used in eIDAS as it is not directly linked to a formal identifier of the natural or legal person. A DID document contains information associated with a DID. They typically express verification methods, such as cryptographic public keys, and services relevant to interactions with the holder. A DID document may be signed by a DID controller. A VC is a set of one or more claims made by an issuer. A VC is a tamper-evident credential that has authorship that can be cryptographically verified.

The flow diagram 600 includes an end device, client, or application 602, and a DID verifier 604. The DID verifier 604, such as an application server or a service provider, is, for example, an entity that receives a DID from an end device for a service request. The flow diagram 600 also includes multiple DID verification services 526, which optionally incorporates the DID registry service/DID resolver 520 of FIG. 5. The flow diagram 600 also includes multiple DID document registry service 522, multiple DID operation participants registry service 518, and VC registry service 524.

At 606, the end-device/client/application 602 sends to the DID verifier 604 (e.g., an application server/service provider application function, which can be an entity that receives a DID from an end device in a service request for a service provision, a service request (or any access request) message which can include DID and any service specific information. The service request message that is being sent between the end-device 602 and the DID verifier 604 can be over any public or proprietary interface. Further a set of other information elements can be sent along with the DID, such as service specific information and any other necessary information.

At 608, the DID verifier 604 determines the DID verification service 526 to be used based on the realm information/information in the DID. The DID verifier 604 sends a DID verification request message to the respective DID verification service 526 (in the ledger-based identity and trust management framework), and the DID verification request message includes the DID verifier's source ID, DID, target DID service type (e.g., the type of service for which the DID is being associated by the DID holder/DID controller and being verified by the DID verifier/service provider). A DID verification request message may also be referred to as a DID verification data request message.

At 610, if no secure connection exists between the DID verifier 604 and the DID verification service 526, the DID verifier initiates a mutual authentication related message exchange with the DID verification service. The DID verifier 604 and the DID verification service 526 can perform mutual authentication and can establish secure connection using any of a variety of public or proprietary techniques.

At 612, the DID verification service 526 sends to the DID verifier 604, an authorization data request message with source identity of the DID verifier 604.

At 614, the DID verifier 604 sends to the DID verification service 526, an authorization data response message which includes a registration ID of the DID verifier 604 and corresponding authorization information for the DID verifier 604. This authorization information can be, for example, an authorization code or token.

In one or more implementations, the registration ID and the corresponding authorization information are the ones received by the DID verifier 604 during its successful role-based registration with a ledger-role based registration management service (L-RMS) to utilize the identity and trust management framework related to perform various operations such as the DID verification and DID holder authentication of any DID subject that requests service(s) from the service provider using a DID.

At 616, the DID verification service 526 sends to the DID operation participants registry service 522, an authorization verification request message, which can include the registration ID (of the DID verifier 604), the source identity (of the DID verifier 604), authorization information (e.g., can be an authorization code or token), access role (e.g., set as ‘DID verifier’), and the service type information (e.g., target DID service type information received at 608). The DID operation participants registry service may also be referred to as a ledger-identity and trust management participant registry service.

At 618, the DID operation participants registry service 518 verifies the authorization information (e.g., authorization code or token) related to the registration ID and the access role by querying the respective ledger/chain (for a related transaction history/records) or by checking an offline or local storage to check if the authorization information and registration ID matches with any of the records related to the registered participant. The DID operation participants registry service also checks if the access role of the participant is correct based on the records.

At 620, if the verification of the registration ID, access role and authorization information are successful, then the DID operation participants registry service 518 sends to the DID verification service 526, an authorization verification response message, which can include the registration ID (of the DID verifier 604), source ID (of the DID verifier 604), and result as ‘successful’. However, if the verification of the registration ID, access role and authorization information do not match with the records, or if the registered access role is different from the one received at 616, then the DID operation participants registry service 518 sends to the DID verification service 526, an authorization verification response message, which can include the registration ID, source ID, and result as ‘failure’.

At 622, on a successful authorization verification of the DID verifier 604, the DID verification service 526 invokes the DID resolver service, which may be co-located with the DID verification service 526 or the DID resolver service ID/address can be configured in the DID verification service 526 based on local policies (or the DID resolver service ID/address related to the DID can be queried and fetched from the L-RMS by providing the DID).

The DID verification service 526 invokes the DID resolver service with the DID and fetches or receives the corresponding DID-related DID document registry service ID/address information. The DID verification service 526 sends to the DID document registry service 522, a DID verification data request, which includes the DID.

However, on an authorization verification failure the DID verification service 526, the operations at 622, 624, 626, 628, and 630 are skipped, and the DID verification service 526 proceeds to 632 discussed below with failure case operations.

At 624, the DID document registry service 522 sends to the VC registry service 524, a VC request message, which includes the DID.

At 626, the DID document registry service 522 checks if there is any DID document available (e.g., in a local storage or in a ledger/chain) for the DID. Further, if the DID documents are available, the DID document service can check the VC registry service ID/address that can be configured in the DID document registry service 522 based on local policies (or the VC registry service ID/address related to the DID can be queried and fetched from the L-RMS by providing a DID).

At 626, the VC registry service 524 fetches the VCs associated with the DID from the respective off-chain, local storage, or ledger and sends to the DID document registry service 522 a VC response message that includes the DID and VCs.

At 628, the DID document registry service 522 fetches the DID documents related to the DID and generates the metadata from the VCs to enable the verifier to authenticate and authorize the DID (and the DID holder) as appropriate for the service provision.

At 630, the DID document registry service 522 sends to the DID verification service 526, a DID verification data response, which includes the DID, DID documents, and the metadata (based on the VCs, e.g., considering one or more claims asserted related to the DID holder or subject respective to the service).

At 632, the DID verification service 526 (after successfully fetching the DID documents and VCs related to the DID that enables DID verification and DID subject authentication), sends to the DID verifier 604, a DID verification response message, which can include a result (with successful indication), DID document, and metadata (related to VCs).

Additionally or alternatively, the DID verification service 526 also verifies the correctness, integrity, and authenticity of the DID using the cryptographic information, security key(s) and verification methods indicated in the DID documents. Further, if the DID verification is successful, then the DID verification service 526, sends to the DID verifier 604 a DID verification response message, which can include a result (with successful indication), DID document, and metadata (related to the VCs).

For the failure case operations, the DID verification service sends to the DID verifier 604, a DID verification response message with result set as ‘failure indication’, and cause information or value (e.g., such as violation code, authorization failure, authentication failure, etc.).

The DID verification response message may also be referred to as a DID verification data response message.

At 634, the DID verifier 604 can use the DID documents to verify (e.g., integrity check and/or authenticate) the DID and authenticate the DID subject. Further, the DID verifier 604 can also use the metadata (based on VCs) associated with the DID subject to authenticate or authorize the DID subject specific to the requested service provision. If the verification (e.g., authentication) of the DID, authentication of the DID subject and the VCs meets the service requirement criteria.

For example, the metadata based on the VCs can enable to authenticate the subject based on the service specific criteria that are asserted by the claims of the VCs linked to the documents such as passport, driving license, any government issued ID card, college/degree certificate etc. E.g., the DID holder should be of age above 15 to consume a service, the DID holder should belong to a location to consume a service, the DID holder should belong to a country or university or company to consume a service, the DID holder should hold a valid driving license to consume a service, and so forth. The DID verifier 604 sends to the end-device 602 (e.g., DID holder/subject), a service response message, which can include the result with success indication, following which the DID holder will be provided with the requested service. A key from the DID document may be used to set up a secure communication between the DID holder and the DID verifier 604.

Additionally or alternatively, if the DID verifier 604 receives a result as success, then the DID verifier 604 can check if the metadata (based on VC) meets the criteria for the service provision related to the DID holder requested service. If the check is successful, the DID verifier 604 sends to the end-device 602 (e.g., DID holder/subject), a service response message that can include the result with success indication, following which the DID holder will be provided with the requested service. A key from the DID document may be used to set up a secure communication between the DID holder and the DID verifier 604.

For the failure case operation, if the DID verifier 604 receives a result as failure, the DID verifier 604, sends to the end-device 602 (e.g., DID holder/subject), a service response message, which can include the result with failure indication and the cause information, following which the DID holder requested service will be denied.

It should be noted that smart contracts can be used by the registry services described herein to keep track and link all DID related entries in the registry, ledger, and so forth.

Accordingly, discussed herein are a role-based registration management service, a DID Operation participants registry service (otherwise termed as Ledger-Identity and trust management participant registry service), a DID Registry/DID Resolver service, a DID Document registry service, a VC data registry service, and a DID verification service. Also discussed are a DID verification procedure and involved message exchanges to enable authentication and authorization of DID holders (e.g., subject/end-user) to provide end-user requested services.

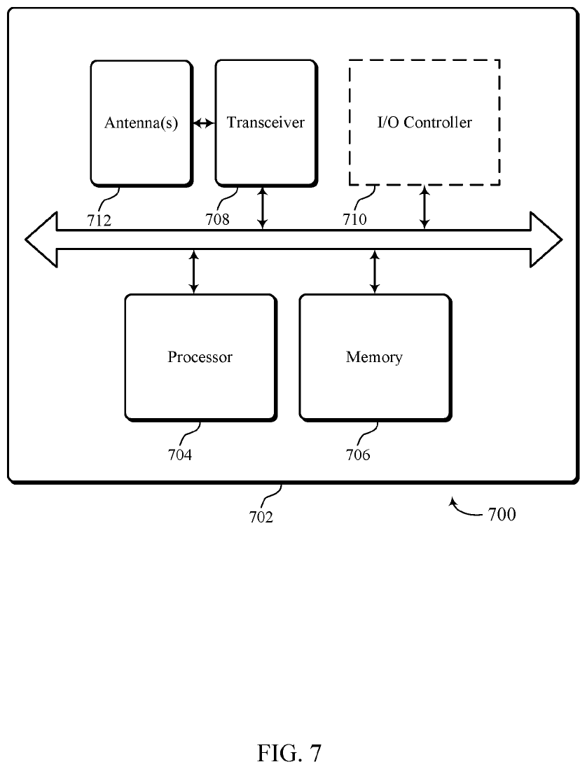

FIG. 7 illustrates an example of a block diagram 700 of a device 702 that supports decentralized identity authentication and authorization in accordance with aspects of the present disclosure. The device 702 may be an example of a device implementing a DID verification service 526 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. Processor 704 may be configured as or otherwise support to: receive, from a DID verifier, a first signaling indicating a DID verification request that includes one or more of a source identifier of the DID verifier, a DID, and a DID service type; transmit, to the DID verifier, a second signaling indicating an authorization data request; receive, from the DID verifier, a third signaling indicating an authorization data response including a registration identifier of the DID verifier and authorization information; transmit, to a first registry service, a fourth signaling indicating an authorization verification request that includes the registration identifier of the DID verifier and the authorization information; receive, from the first registry service, a fifth signaling indicating an authorization verification response of success or failure; transmit, to the DID verifier, a sixth signaling indicating a DID verification response of DID verification success or DID verification failure.

Additionally or alternatively, the processor 704 may be configured to or otherwise support:, in response to the fifth signaling indicating the authorization verification response of success: transmit, to a second registry service, a seventh signaling indicating a DID verification data request that includes the DID; receive, from the second registry service, an eighth signaling indicating a DID verification data response that includes the DID, one or more DID documents, and metadata; and transmit, to the DID verifier, the sixth signaling indicating the DID verification response of DID verification success, a DID document and metadata; in response to the fifth signaling indicating the authorization verification response of failure: transmit, to the DID verifier, the sixth signaling indicating the DID verification response of DID verification failure; where the sixth signaling further indicates a reason for the DID verification response of DID verification failure; where the DID verifier comprises an application server or service provider application function; to transmit, to the DID verifier, a seventh signaling to establish a secure connection between the DID verifier and the apparatus; where the authorization data request includes an identifier of the DID verifier; where the authorization verification request includes one or more of the registration identifier of the DID verifier, an identifier of the DID verifier, an indication of an access role as DID verifier, and the authorization information; where the authorization information comprises an authorization code or token; where the authorization verification response includes one or more of the registration identifier of the DID verifier, an identifier of the DID verifier, and the authorization verification response of success or failure.

For example, the processor 704 may support wireless communication at the device 702 in accordance with examples as disclosed herein. Processor 704 may be configured as or otherwise support a means for: receiving, from a DID verifier, a first signaling indicating a DID verification request that includes one or more of a source identifier of the DID verifier, a DID, and a DID service type; transmitting, to the DID verifier, a second signaling indicating an authorization data request; receiving, from the DID verifier, a third signaling indicating an authorization data response including a registration identifier of the DID verifier and authorization information; transmitting, to a first registry service, a fourth signaling indicating an authorization verification request that includes the registration identifier of the DID verifier and the authorization information; receiving, from the first registry service, a fifth signaling indicating an authorization verification response of success or failure; and transmitting, to the DID verifier, a sixth signaling indicating a DID verification response of DID verification success or DID verification failure.

Additionally or alternatively, the processor 704 may be configured to or otherwise support: in response to the fifth signaling indicating the authorization verification response of success: transmitting, to a second registry service, a seventh signaling indicating a DID verification data request that includes the DID; receiving, from the second registry service, an eighth signaling indicating a DID verification data response that includes the DID, one or more DID documents, and metadata; and transmitting, to the DID verifier, the sixth signaling indicating the DID verification response of DID verification success, a DID document and metadata; in response to the fifth signaling indicating the authorization verification response of failure: transmitting, to the DID verifier, the sixth signaling indicating the DID verification response of DID verification failure; where the sixth signaling further indicates a reason for the DID verification response of DID verification failure; where the DID verifier comprises an application server or service provider application function; transmitting, to the DID verifier, a seventh signaling to establish a secure connection between the DID verifier and an apparatus implementing the method; where the authorization data request includes an identifier of the DID verifier; where the authorization verification request includes one or more of the registration identifier of the DID verifier, an identifier of the DID verifier, an indication of an access role as DID verifier, and the authorization information; where the authorization information comprises an authorization code or token; where the authorization verification response includes one or more of the registration identifier of the DID verifier, an identifier of the DID verifier, and the authorization verification response of success or failure.

The processor 704 of the device 702 may support wireless communication in accordance with examples as disclosed herein. The processor 704 may include at least one controller coupled with at least one memory, and may be configured to or operable to cause the processor to perform the techniques discussed herein.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

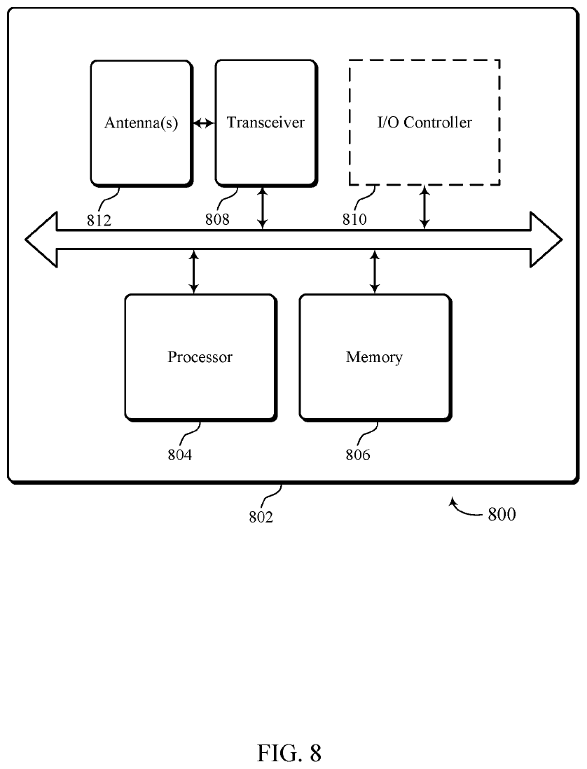

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712 FIG. 8 illustrates an example of a block diagram 800 of a device 802 that supports decentralized identity authentication and authorization in accordance with aspects of the present disclosure. The device 802 may be an example of device implementing a DID operation participants registry service 518 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support to: receive, from a DID verification service, a first signaling indicating an authorization verification request that includes a registration identifier of a DID verifier and authorization information; transmit, to the DID verification service, a second signaling indicating an authorization verification response of success or failure.

Additionally or alternatively, the processor 804 may be configured to or otherwise support to: check a ledger or storage to determine whether the registration identifier and the authorization information match a record of a participant involved in an identity and trust management framework, and whether an access role of the participant is correct; and verify, based on the checking, the authorization information related to the registration identifier; where the authorization verification request includes one or more of the registration identifier of the DID verifier, an identifier of the DID verifier, an indication of an access role as DID verifier, and the authorization information; where the authorization information comprises an authorization code or token; where the authorization verification response includes one or more of the registration identifier of the DID verifier, an identifier of the DID verifier, and the authorization verification response of success or failure.

For example, the processor 804 may support wireless communication at the device 802 in accordance with examples as disclosed herein. Processor 804 may be configured as or otherwise support a means for receiving, from a DID verification service, a first signaling indicating an authorization verification request that includes a registration identifier of a DID verifier and authorization information; and transmitting, to the DID verification service, a second signaling indicating an authorization verification response of success or failure.

Additionally or alternatively, the processor 804 may be configured to or otherwise support: checking a ledger or storage to determine whether the registration identifier and the authorization information match a record of a participant involved in an identity and trust management framework, and whether an access role of the participant is correct; and verifying, based on the checking, the authorization information related to the registration identifier; where the authorization verification request includes one or more of the registration identifier of the DID verifier, an identifier of the DID verifier, an indication of an access role as DID verifier, and the authorization information; where the authorization information comprises an authorization code or token; where the authorization verification response includes one or more of the registration identifier of the DID verifier, an identifier of the DID verifier, and the authorization verification response of success or failure.

The processor 804 of the device 802 may support wireless communication in accordance with examples as disclosed herein. The processor 804 may include at least one controller coupled with at least one memory, and may be configured to or operable to cause the processor to perform the techniques discussed herein.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

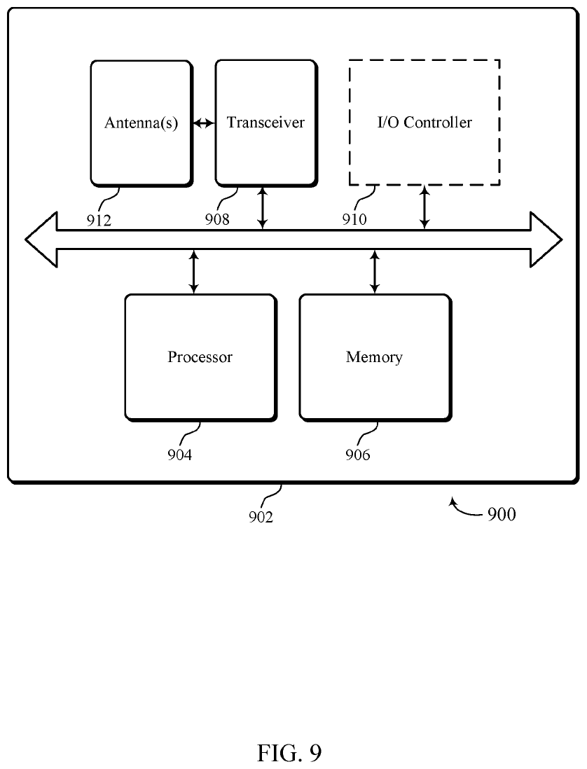

FIG. 9 illustrates an example of a block diagram 900 of a device 902 that supports decentralized identity authentication and authorization in accordance with aspects of the present disclosure. The device 902 may be an example of a device implementing a DID document registry service 522 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support to: receive, from a DID verification service, a first signaling indicating a DID verification data request that includes the DID; transmit, to the DID verification service, a second signaling indicating a DID verification data response that includes the DID, one or more DID documents, and metadata.

Additionally or alternatively, the processor 904 may be configured to or otherwise support: transmit, to a VC registry service, a third signaling indicating a VC request that includes the DID; and receive, from the VC registry service, a fourth signaling indicating a VC response that includes the DID and VCs associated with the DID; to: fetch the one or more DID documents related to the DID; and generate the metadata from VCs to enable a DID verifier to authenticate and authorize the DID and a DID holder.

For example, the processor 904 may support wireless communication at the device 902 in accordance with examples as disclosed herein. Processor 904 may be configured as or otherwise support a means for receiving, from a decentralized identifier (DID) verification service, a first signaling indicating a DID verification data request that includes the DID; and transmitting, to the DID verification service, a second signaling indicating a DID verification data response that includes the DID, one or more DID documents, and metadata.

Additionally or alternatively, the processor 904 may be configured to or otherwise support: transmitting, to a VC registry service, a third signaling indicating a VC request that includes the DID; and receiving, from the VC registry service, a fourth signaling indicating a VC response that includes the DID and VCs associated with the DID; fetching the one or more DID documents related to the DID; and generating the metadata from VCs to enable a DID verifier to authenticate and authorize the DID and a DID holder.

The processor 904 of the device 902 may support wireless communication in accordance with examples as disclosed herein. The processor 904 may include at least one controller coupled with at least one memory, and may be configured to or operable to cause the processor to perform the techniques discussed herein.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

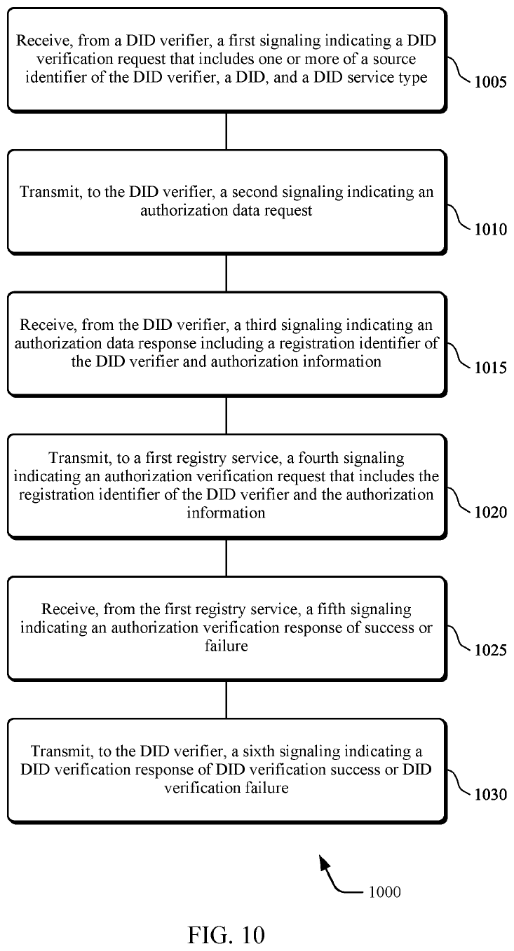

FIG. 10 illustrates a flowchart of a method 1000 that supports decentralized identity authentication and authorization in accordance with aspects of the present disclosure. The operations of the method 1000 may be implemented by a device or its components as described herein. For example, the operations of the method 1000 may be performed by a device implementing a DID verification service 526 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1005, the method may include receiving, from a DID verifier, a first signaling indicating a DID verification request that includes one or more of a source identifier of the DID verifier, a DID, and a DID service type. The operations of 1005 may be performed in accordance with examples as described herein. In some implementations, aspects of the operations of 1005 may be performed by a device as described with reference to FIG. 1.

At 1010, the method may include transmitting, to the DID verifier, a second signaling indicating an authorization data request. The operations of 1010 may be performed in accordance with examples as described herein. In some implementations, aspects of the operations of 1010 may be performed by a device as described with reference to FIG. 1.

At 1015, the method may include receiving, from the DID verifier, a third signaling indicating an authorization data response including a registration identifier of the DID verifier and authorization information. The operations of 1015 may be performed in accordance with examples as described herein. In some implementations, aspects of the operations of 1015 may be performed by a device as described with reference to FIG. 1.

At 1020, the method may include transmitting, to a first registry service, a fourth signaling indicating an authorization verification request that includes the registration identifier of the DID verifier and the authorization information. The operations of 1020 may be performed in accordance with examples as described herein. In some implementations, aspects of the operations of 1020 may be performed by a device as described with reference to FIG. 1.

At 1025, the method may include receiving, from the first registry service, a fifth signaling indicating an authorization verification response of success or failure. The operations of 1025 may be performed in accordance with examples as described herein. In some implementations, aspects of the operations of 1025 may be performed by a device as described with reference to FIG. 1.

At 1030, the method may include transmitting, to the DID verifier, a sixth signaling indicating a DID verification response of DID verification success or DID verification failure. The operations of 1030 may be performed in accordance with examples as described herein. In some implementations, aspects of the operations of 1030 may be performed by a device as described with reference to FIG. 1.

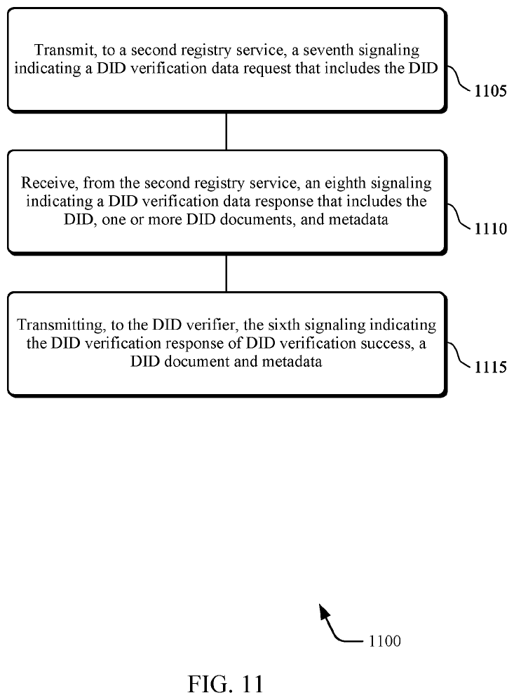

FIG. 11 illustrates a flowchart of a method 1100 that supports decentralized identity authentication and authorization in accordance with aspects of the present disclosure. The operations of the method 1100 may be implemented by a device or its components as described herein. For example, the operations of the method 1100 may be performed by a device implementing a DID verification service 526 as described with reference to FIGS. 1 through 9. In some implementations, the device may execute a set of instructions to control the function elements of the device to perform the described. functions. Additionally, or alternatively, the device may perform aspects of the described functions using special-purpose hardware.

At 1105, the method may include transmitting, to a second registry service, a seventh signaling indicating a DID verification data request that includes the DID. The operations of 1105 may be performed in accordance with examples as described herein. In some implementations, aspects of the operations of 1105 may be performed by a device as described with reference to FIG. 1.

At 1110, the method may include receiving, from the second registry service, an eighth signaling indicating a DID verification data response that includes the DID, one or more DID documents, and metadata. The operations of 1110 may be performed in accordance with examples as described herein. In some implementations, aspects of the operations of 1110 may be performed by a device as described with reference to FIG. 1.

At 1115, the method may include transmitting, to the DID verifier, the sixth signaling indicating the DID verification response of DID verification success, a DID document and metadata. The operations of 1115 may be performed in accordance with examples as described herein. In some implementations, aspects of the operations of 1115 may be performed by a device as described with reference to FIG. 1.

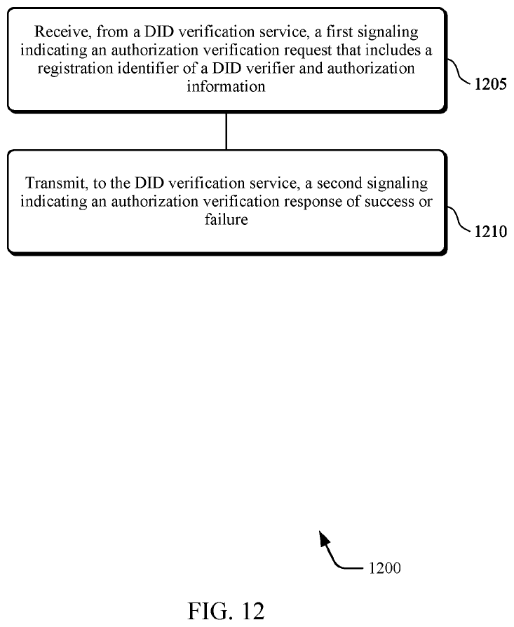

FIG. 12 illustrates a flowchart of a method 1200 that supports decentralized identity authentication and authorization in accordance with aspects of the present disclosure. The operations of the method 1200 may be implemented by a device or its components as described herein. For example, the operations of the method 1200 may be performed by a device implementing a DID operation participants registry service 518 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1205, the method may include receiving, from a DID verification service, a first signaling indicating an authorization verification request that includes a registration identifier of a DID verifier and authorization information. The operations of 1205 may be performed in accordance with examples as described herein. In some implementations, aspects of the operations of 1205 may be performed by a device as described with reference to FIG. 1.

At 1210, the method may include transmitting, to the DID verification service, a second signaling indicating an authorization verification response of success or failure. The operations of 1210 may be performed in accordance with examples as described herein. In some implementations, aspects of the operations of 1210 may be performed by a device as described with reference to FIG. 1.

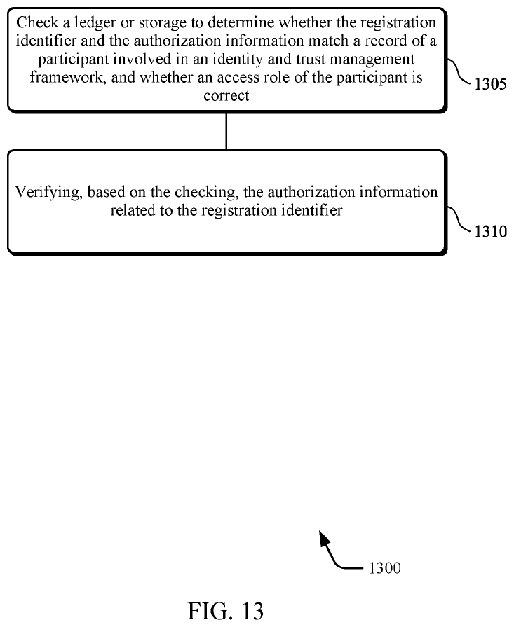

FIG. 13 illustrates a flowchart of a method 1300 that supports decentralized identity authentication and authorization in accordance with aspects of the present disclosure. The operations of the method 1300 may be implemented by a device or its components as described herein. For example, the operations of the method 1300 may be performed by a device implementing a DID operation participants registry service 518 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1305, the method may include checking a ledger or storage to determine whether the registration identifier and the authorization information match a record of a participant involved in an identity and trust management framework, and whether an access role of the participant is correct. The operations of 1305 may be performed in accordance with examples as described herein. In some implementations, aspects of the operations of 1305 may be performed by a device as described with reference to FIG. 1.

At 1310, the method may include verifying, based on the checking, the authorization information related to the registration identifier. The operations of 1310 may be performed in accordance with examples as described herein. In some implementations, aspects of the operations of 1310 may be performed by a device as described with reference to FIG. 1.

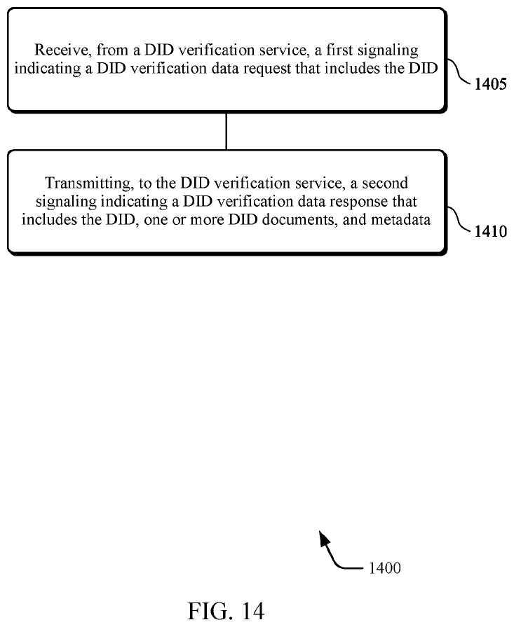

FIG. 14 illustrates a flowchart of a method 1400 that supports decentralized identity authentication and authorization in accordance with aspects of the present disclosure. The operations of the method 1400 may be implemented by a device or its components as described herein. For example, the operations of the method 1400 may be performed by a device implementing a DID document registry service 522 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1405, the method may include receiving, from a DID verification service, a first signaling indicating a DID verification data request that includes the DID. The operations of 1405 may be performed in accordance with examples as described herein. In some implementations, aspects of the operations of 1405 may be performed by a device as described with reference to FIG. 1.

At 1410, the method may include transmitting, to the DID verification service, a second signaling indicating a DID verification data response that includes the DID, one or more DID documents, and metadata. The operations of 1410 may be performed in accordance with examples as described herein. In some implementations, aspects of the operations of 1410 may be performed by a device as described with reference to FIG. 1.

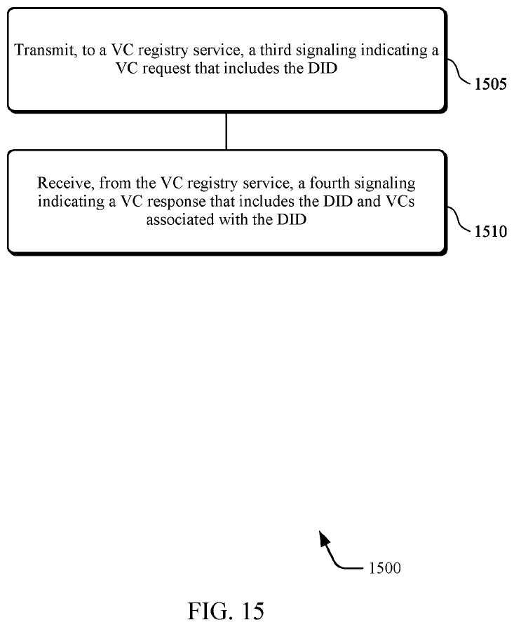

FIG. 15 illustrates a flowchart of a method 1500 that supports decentralized identity authentication and authorization in accordance with aspects of the present disclosure. The operations of the method 1500 may be implemented by a device or its components as described herein. For example, the operations of the method 1500 may be performed by a device implementing a DID document registry service 522 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1505, the method may include transmitting, to a VC registry service, a third signaling indicating a VC request that includes the DID. The operations of 1505 may be performed in accordance with examples as described herein. In some implementations, aspects of the operations of 1505 may be performed by a device as described with reference to FIG. 1.

At 1510, the method may include receiving, from the VC registry service, a fourth signaling indicating a VC response that includes the DID and VCs associated with the DID. The operations of 1510 may be performed in accordance with examples as described herein. In some implementations, aspects of the operations of 1510 may be performed by a device as described with reference to FIG. 1.

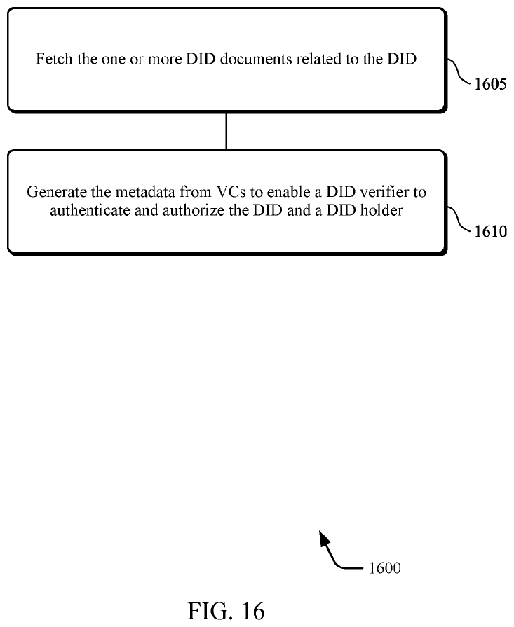

FIG. 16 illustrates a flowchart of a method 1600 that supports decentralized identity authentication and authorization in accordance with aspects of the present disclosure. The operations of the method 1600 may be implemented by a device or its components as described herein. For example, the operations of the method 1600 may be performed by a device implementing a DID document registry service 522 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1605, the method may include fetching the one or more DID documents related to the DID. The operations of 1605 may be performed in accordance with examples as described herein. In some implementations, aspects of the operations of 1605 may be performed by a device as described with reference to FIG. 1.

At 1610, the method may include generating the metadata from VCs to enable a DID verifier to authenticate and authorize the DID and a DID holder. The operations of 1610 may be performed in accordance with examples as described herein. In some implementations, aspects of the operations of 1610 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and operable to cause the apparatus to:
receive, from a decentralized identifier (DID) verifier, a DID verification request that includes one or more of a source identifier of the DID verifier, a DID, and a DID service type;
transmit, to the DID verifier, an authorization data request;
receive, from the DID verifier, an authorization data response including a registration identifier of the DID verifier and authorization information;
transmit, to a first registry service, an authorization verification request that includes the registration identifier of the DID verifier and the authorization information;
receive, from the first registry service, an authorization verification response of success or failure;
transmit, to the DID verifier, DID verification response of DID verification success or DID verification failure.

2. The apparatus of claim 1, wherein the at least one processor is further operable to cause the apparatus to, in response to the authorization verification response indicating success:
transmit, to a second registry service, a DID verification data request that includes the DID;
receive, from the second registry service, a DID verification data response that includes the DID, one or more DID documents, and metadata; and
transmit, to the DID verifier, the DID verification response of DID verification success, a DID document and metadata.

3. The apparatus of claim 1, wherein the at least one processor is further operable to cause the apparatus to, in response to the authorization verification response indicating failure:
transmit, to the DID verifier, the DID verification response of DID verification failure.

4. The apparatus of claim 3, wherein the DID verification response of DID verification failure further indicates a reason for the DID verification response of DID verification failure.

5. The apparatus of claim 1, wherein the DID verifier comprises an application server or service provider application function.

6. The apparatus of claim 1, wherein the at least one processor is further operable to cause the apparatus to establish a secure connection between the DID verifier and the apparatus.

7. The apparatus of claim 1, wherein the authorization data request includes an identifier of the DID verifier.

8. The apparatus of claim 1, wherein the authorization verification request includes one or more of the registration identifier of the DID verifier, an identifier of the DID verifier, an indication of an access role as DID verifier, and the authorization information.

9. The apparatus of claim 1, wherein the authorization information comprises an authorization code or token.

10. The apparatus of claim 1, wherein the authorization verification response includes one or more of the registration identifier of the DID verifier, an identifier of the DID verifier, and the authorization verification response of success or failure.

11. An apparatus for wireless communication, comprising:
at least one memory; and
at least one processor coupled with the at least one memory and operable to:
receive, from a decentralized identifier (DID) verification service, an authorization verification request that includes a registration identifier of a DID verifier and authorization information;
transmit, to the DID verification service, an authorization verification response of success or failure.

12. The apparatus of claim 11, wherein the processor is further operable to:
check a ledger or storage to determine whether the registration identifier and the authorization information match a record of a participant involved in an identity and trust management framework, and whether an access role of the participant is correct; and
verify, based on the checking, the authorization information related to the registration identifier.

13. The apparatus of claim 11, wherein the authorization verification request includes one or more of the registration identifier of the DID verifier, an identifier of the DID verifier, an indication of an access role as DID verifier, and the authorization information.

14. The apparatus of claim 11, wherein the authorization information comprises an authorization code or token.

15. The apparatus of claim 11, wherein the authorization verification response includes one or more of the registration identifier of the DID verifier, an identifier of the DID verifier, and the authorization verification response of success or failure.

16. An apparatus for wireless communication, comprising:
at least one memory; and
at least one processor coupled with the at least one memory and operable to:
receive, from a decentralized identifier (DID) verification service, a DID verification data request that includes the DID;
transmit, to the DID verification service, a DID verification data response that includes the DID, one or more DID documents, and metadata.

17. The apparatus of claim 16, wherein the processor is further operable to:
transmit, to a verifiable credential (VC) registry service, a VC request that includes the DID; and
receive, from the VC registry service, a a VC response that includes the DID and VCs associated with the DID.

18. The apparatus of claim 16, wherein the processor is further operable to:
fetch the one or more DID documents related to the DID; and
generate the metadata from verifiable credentials (VCs) to enable a DID verifier to authenticate and authorize the DID and a DID holder.

19. A method, comprising:
receiving, from a decentralized identifier (DID) verifier, a DID verification request that includes one or more of a source identifier of the DID verifier, a DID, and a DID service type;
transmitting, to the DID verifier, an authorization data request;
receiving, from the DID verifier, an authorization data response including a registration identifier of the DID verifier and authorization information;
transmitting, to a first registry service, an authorization verification request that includes the registration identifier of the DID verifier and the authorization information;
receiving, from the first registry service, an authorization verification response of success or failure; and
transmitting, to the DID verifier, a DID verification response of DID verification success or DID verification failure.

20. The method of claim 19, further comprising, in response to the authorization verification response indicating success:
transmitting, to a second registry service, a DID verification data request that includes the DID;
receiving, from the second registry service, a DID verification data response that includes the DID, one or more DID documents, and metadata; and
transmitting, to the DID verifier, the DID verification response of DID verification success, a DID document and metadata.
